(19) United States
(12) Patent Application Publication
(10) Pub. No.: US 2008/0271062 A1
(43) Pub. Date: Oct. 30, 2008

(54) Optical disc apparatus

(75) Inventors: Shinya Asano, Tokyo (JP); Nozomu Harada, Kawasaki (JP); Makoto Ibe, Hitachinaka (JP); Shinya Tsubota, Mito (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/986,224

(22) Filed: Nov. 20, 2007

(30) Foreign Application Priority Data
Apr. 27, 2007 (JP) 2007-119494

(51) Int. Cl. G11B 17/04; G11B 17/03; G11B 33/02

(52) U.S. Cl. 720/601

(57) ABSTRACT

To prevent deformation of a chassis due to an impact force in an optical disc apparatus, there is provided a tray for inserting/ejecting an optical disc into/from an apparatus body, with the chassis connected thereto through vibration proof materials in plural portions in a surface opposite a disc placing surface. The tray has projecting portions projecting in a chassis direction in positions facing the chassis in peripheral portions of the plural connecting portions. The projecting portion is located at a position higher than a tray plane with which the vibration proof material comes into contact, and lower than the surface of a chassis facing the tray. When the vibration proof material is compressed and deformed due to the impact force, the projecting portion comes into contact with the chassis facing surface, to reduce the amount of deformation of the vibration proof material and thereby prevent deformation of the chassis.

### CLAIM OF PRIORITY

The present application claims priority from Japanese application serial No. P2007-119494, filed on Apr. 27, 2007, the content of which is hereby incorporated by reference into this application.

### BACKGROUND OF THE INVENTION

1. Technical Field of the Invention

The present invention relates to an optical disc apparatus, and more particularly to a configuration of a tray for inserting and ejecting an optical disc.

2. Description of the Related Art

Recently there has been a need for a thin optical disc apparatus (hereinafter referred to as a slim drive) that can perform recoding or reproduction by loading a blue-laser optical disc such as BD (Blu-ray Disc) and HD-DVD, as well as a red-laser optical disc such as DVD and CD. In response to such a need, an optical pickup configured to have an optical system for the blue-laser optical disc (hereinafter referred to as blue-laser optics) and an optical system for the red-laser optical disc (hereinafter referred to as red-laser optics), has been developed for practical use. The optical pickup of such a configuration has increased size and weight as the two sets of optics are mounted thereon. The increase in size of the optical pickup leads to an increase of the width of the space along which the optical pickup moves. For this reason, it is necessary to reduce the width of a chassis forming an outer peripheral portion as a base of a mechanism portion on which the optical pickup is mounted. As a result, the mechanical strength is reduced.

The slim drive is used mounted, for example, on a notebook PC or other device, and is needed to reduce the size and weight as a whole. For this reason, it is necessary to maintain a lightweight state in the mechanism portion on which the optical pickup including the two sets of optics is mounted. The maintenance of the lightweight state is achieved, for example, by reducing the width and thickness of the chassis. However, further reduction of such dimensions also reduces the strength of the mechanism portion, thereby reducing the reliability of the apparatus.

There is a related technology for improving the strength of a mechanism portion in an optical disc apparatus including a slim drive, which is described in the patent document JP publication No. P2005-251321. That is, JP publication No. P2005-251321 describes a frame (corresponding to a chassis) that forms the outer peripheral portion of a pickup module (mechanism portion) of an optical disc apparatus. The frame is configured in such a way that an inside portion is formed inside the frame, an upright portion is formed integrally with the inside portion, and an outside portion is formed integrally with the upright portion in the outside of the frame.

### SUMMARY OF THE INVENTION

When a notebook PC or other device is dropped by accident, an impact force due to the drop is applied to an optical disc apparatus incorporated therein, often resulting in the apparatus not operating normally as a mechanism portion inside the optical disc apparatus is deformed or a circuit portion is destroyed. FIGS. 7 to 10A-10C are views illustrating deformation of a chassis of a mechanism portion when an impact force due to drop and the like, is applied to an existing optical disc apparatus (slim drive). In an existing optical disc apparatus 100′ shown in FIG. 7, a large structural optical pickup 4 including red-laser optics 41 and blue-laser optics 42, a pickup moving mechanism, and a disc motor 3 are all mounted on a chassis 5 of a mechanism portion. The chassis 5 is connected to a tray 6 through vibration proof materials in three positions A, B, and C. Reference numeral 3a denotes a turntable on which an optical disc is placed, reference numeral 8 denotes a flexible printed circuit (FPC), and reference numeral 50 denotes a bottom case for covering the back surface side (negative Z-axis direction side) of the apparatus. The chassis 5 is connected to the tray 6 in the three positions A, B, and C with the configuration shown in FIGS. 8A, 8B. In other words, the chassis 5 is connected to the tray 6 through a damper A 11a as the vibration proof material at the position A (FIG. 8A), and connected to the tray 6 through a damper C 11c as the vibration proof material at the position C (FIG. 8C). Although not shown here, the chassis 5 is also connected to the tray 6 at the position B with the same configuration as the position C. At the position A, the chassis 5 is supported at a position of height hₐ from a tray surface Sa by the damper A 11a. The tray 6 has a rib 13a as a projecting portion, which is provided around the damper A 11a and projecting in a direction of the chassis 5. A gap of a distance gₐ is formed between a tip end surface of the rib 13a and the chassis 5 (FIG. 8A). At the position C, the chassis 5 is supported at a position of height h_{c} from a tray surface Sc by the damper C 11c. There is no projecting portion in the peripheral portion of the damper C 11c (FIG. 8B). The chassis 5 is formed, for example, by a steel plate with a thickness of 1.0×10⁻³ m. Inside the bottom case 50, a bottom cover 20 is fixed on the side of the tray 6 by screws 30 in the three positions A, B, and C. In the three positions, the vibration proof materials are supported in the end surfaces thereof on the side of the negative Z-axis direction by a plane of the bottom cover 20, respectively. The center of gravity of the mechanism portion is located closer to the position A in the vicinity of which a disc motor 3 is located, than the positions B and C.

With such a configuration, when an impact force is applied in the negative Z-axis direction (the chassis 5 side), a large deformation occurs in an end 5a of the chassis 5 (hereinafter referred to as a chassis end) in the order shown in FIGS. 9A to 9C. In other words, when an impact force is applied to the negative Z-axis direction (FIG. 9A), the chassis 5 is pushed in the negative Z-axis direction by the impact force, and the damper A 11a is largely compressed and deformed in the negative Z-axis direction at the position A close to the center of gravity of the mechanism portion. The chassis 5 is largely inclined between the position A and the positions B and C. As a result, the chassis end 5a collides (contacts) against a surface of the tray 6 (FIG. 9B), and a large deformation occurs in the chassis end 5a, which remains as a large plastic deformation even after the impact force is removed, namely, the state of the chassis end 5a changes from 5a₁ to 5a₄ (FIG. 9C). In FIGS. 9A to 9C, reference numeral 11b denotes a damper B as the vibration proof material to connect the chassis 5 to the tray 6. On the other hand, when an impact force is applied to the positive Z-axis direction (the tray 6 side), a large deformation occurs in the chassis end 5a in the order shown in FIGS. 10A to 10C. In other words, when an impact force is applied to the positive Z-axis direction (FIG. 10A), the damper A 11a is compressed and deformed in the positive Z-axis direction by the impact force at the position A. The surface of the chassis 5 comes into contact with the tip end surface of the rib 13a at a position in which the damper A 11a is compressed and deformed by the distance gₐ in the positive Z-axis direction. In this way, the damper A 11a is prevented from being further compressed and deformed. The damper B 11b at the position B and the damper C 11c at the position C are largely compressed and deformed in the positive Z-axis direction, respectively. The chassis 5 is also largely inclined between the position A and the positions B and C. As a result, the chassis end 5a collides (contacts) against the surface of the tray 6 (FIG. 10B), and a large deformation occurs in the chassis end 5a, which remains as a large plastic deformation even after the impact force is removed, namely, the state of the chassis 5a changes from 5a₁ to 5a₅ (FIG. 10C). As described above, in the connection structure between the existing chassis 5 and tray 6, the large deformation occurs in the chassis end 5a when the impact force is applied either in the negative Z-axis direction or in the positive Z-axis direction. As a result, the normal recording or reproducing operation as the optical disc apparatus could be prevented.

Further, the technology described in JP publication No. P2005-251321 is to improve the frame strength by projecting the cross section of the frame (chassis) inward in relation to the inside portion, outward in relation to the outside portion, and upward in relation to the upright portion. Thus, in the technology described in the application, it would be expected to increase the frame strength and improve the mechanical properties including the impact resistance. However, the increase of the cross sectional area of the frame leads to increase in size and weight of the frame.

In view of the circumstances of the related art described above, it is desirable for the optical disc apparatus to prevent deformation of the chassis due to the impact force, without material change and increase in size and weight of the chassis of the mechanism portion.

The present invention aims to solve such a problem and to provide an optical disc apparatus with high reliability.

The present invention is a technology capable of solving the above problem and achieving the above object.

That is, in the present invention, an optical disc apparatus has a tray to which a chassis of a mechanism portion is connected through vibration proof materials in plural positions in a surface opposite a surface on which a disc is placed. The tray has projecting portions projecting in the chassis direction respectively in positions facing the chassis in the peripheral portions of the plural connecting portions of the chassis. Each of the projecting portions has a tip end surface located at a position that is higher than the height of the tray plane with which the vibration proof material comes into contact, and is lower than the height of the surface of the chassis facing the tray. By coming into contact with the surface of the chassis facing the tray, the projecting portion reduces the amount of compressive deformation of the vibration proof material due to impact force and thereby prevents the deformation of the chassis.

### BRIEF DESCRIPTION OF THE DRAWINGS

FIG. 1 is a view showing an example of the configuration of an optical disc apparatus as an embodiment of the present invention;

FIG. 2 is a view showing a state of a tray connected to a chassis in the optical disc apparatus of FIG. 1;

FIG. 3 is a view showing a connection structure of the chassis to the tray as well as a tray configuration in the peripheral portion thereof in the optical disc apparatus of FIG. 1;

FIG. 4 is a view showing a structure of the peripheral portions of the connecting portions of the chassis in the optical disc apparatus of FIG. 1;

FIGS. 5A, 5B, 5C are views illustrating deformation of the chassis when an impact force is applied to the optical disc apparatus of FIG. 1;

FIGS. 6A, 6B, 6C are views illustrating deformation of the chassis when an impact force is applied to the optical disc apparatus of FIG. 1;

FIG. 7 is a view showing an example of the configuration of an existing optical disc apparatus;

FIGS. 8A, 8B are views each showing a connection structure of the chassis to the tray as well as a tray configuration in the peripheral portion thereof in the existing optical disc apparatus;

FIGS. 9A, 9B, 9C are views illustrating deformation of the chassis when an impact force is applied to the existing optical disc apparatus; and

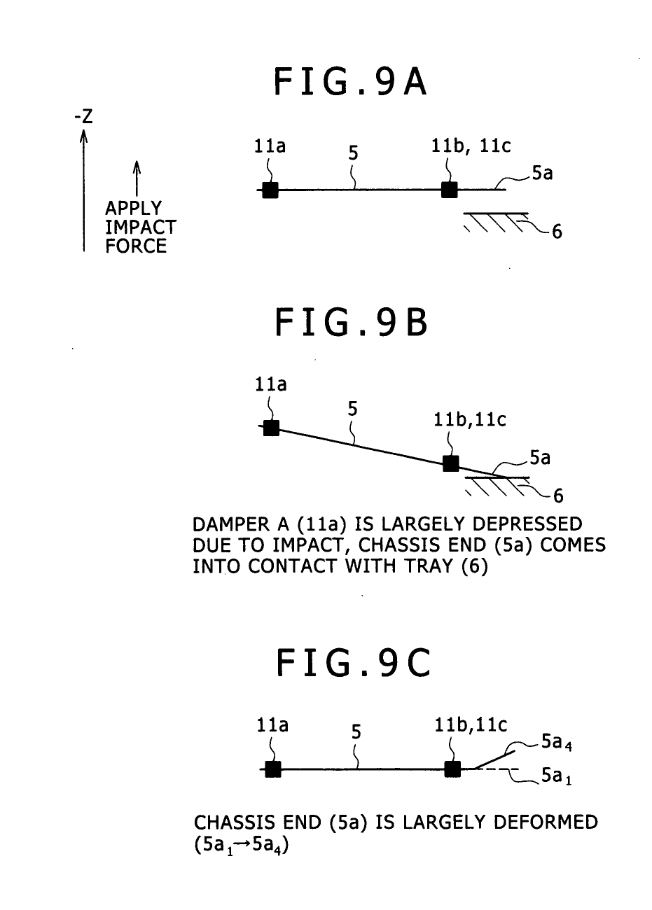

FIGS. 10A, 10B, 10C are views illustrating deformation of the chassis when an impact force is applied to the existing optical disc apparatus.

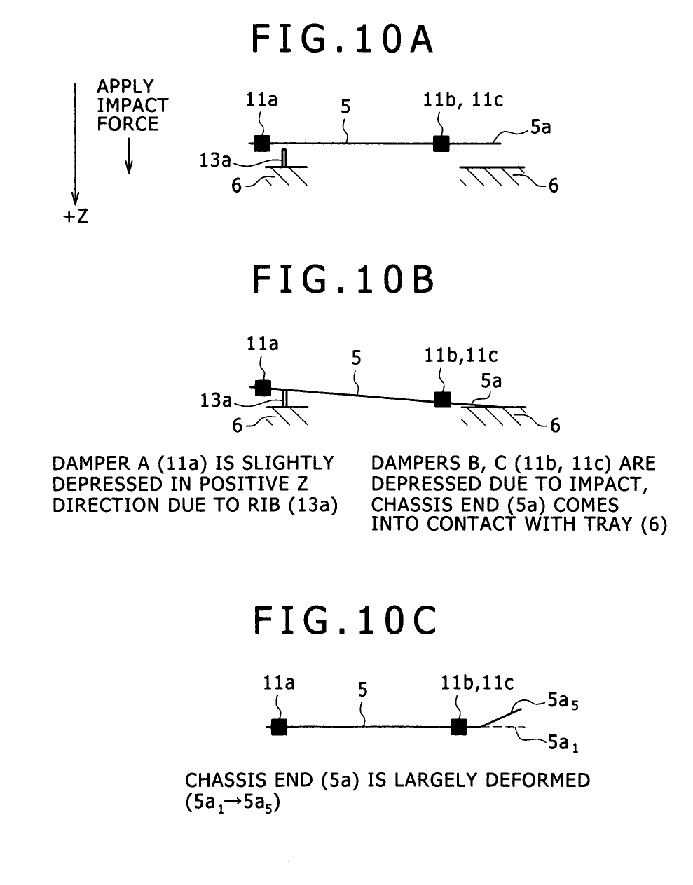

### DETAILED DESCRIPTION OF THE PREFERRED EMBODIMENT

Hereinafter, a preferred embodiment of the present invention will be described with reference to the accompanying drawings.

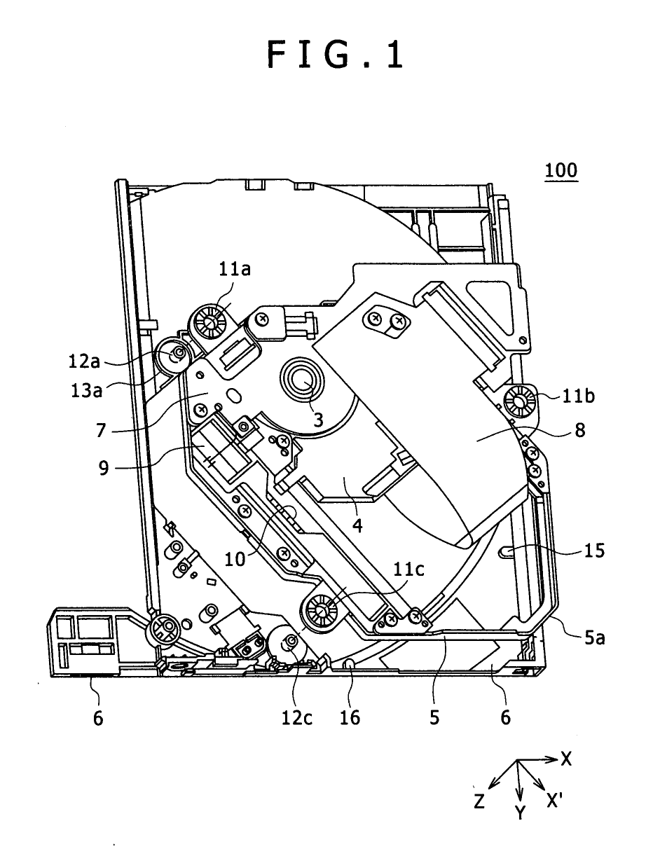

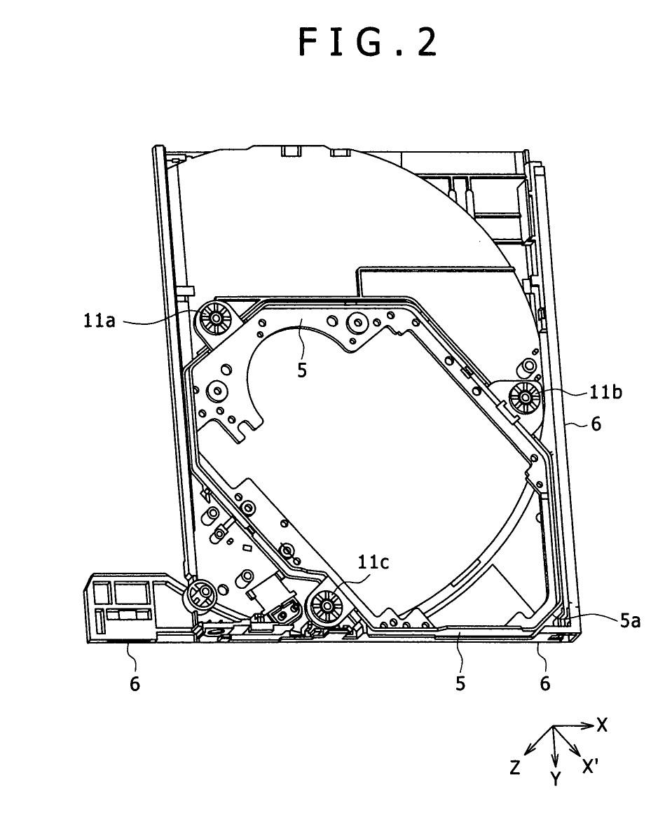

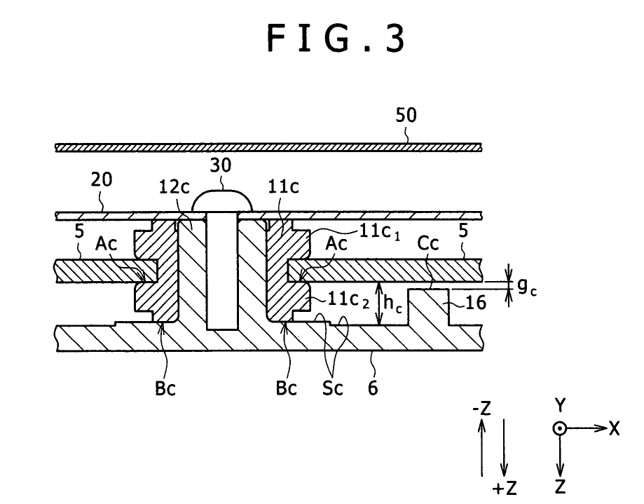

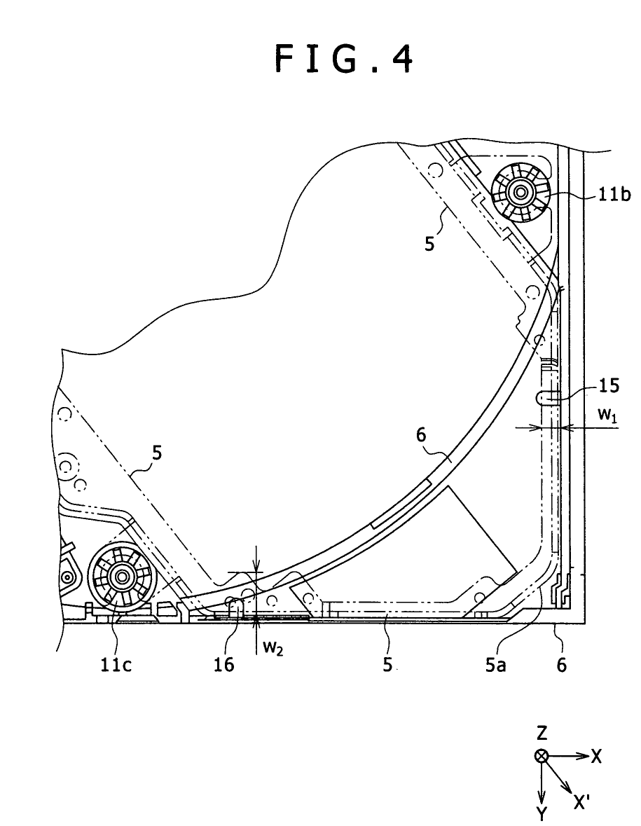

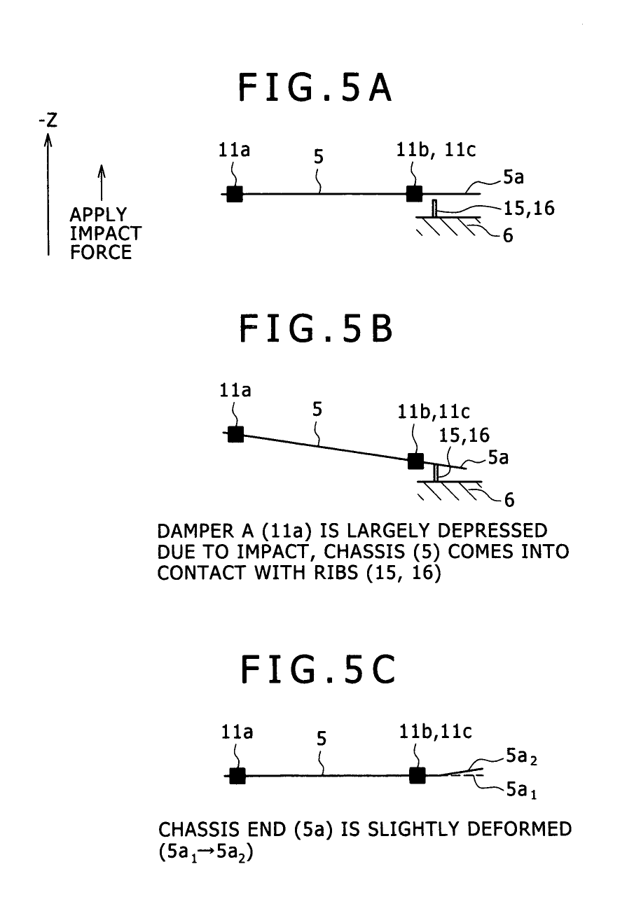

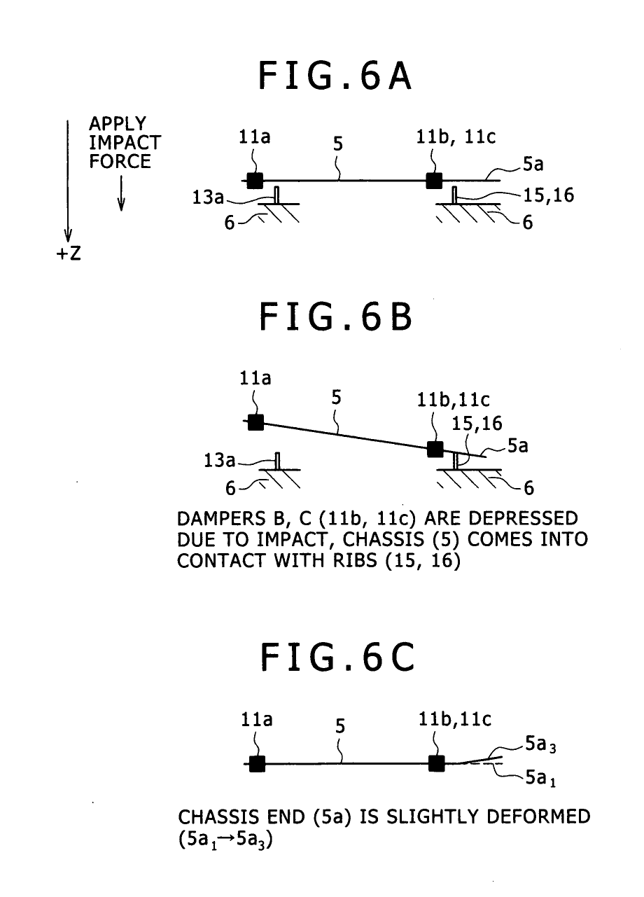

FIGS. 1 to 6A-6C are views illustrating an embodiment of the present invention. FIG. 1 is a view showing a configuration of an optical disc apparatus as an embodiment of the present invention, which is a perspective view showing a state in which a chassis is removed from a tray. FIG. 2 is a plan view showing a state in which the chassis is connected to the tray in the optical disc apparatus of FIG. 1. FIG. 3 is a cross-sectional view showing a connection structure of the chassis to the tray as well as a tray configuration in the peripheral portion thereof in the optical disc apparatus of FIG. 1. FIG. 4 is a plan view of the peripheral portions of the connecting portions of the chassis in the optical disc apparatus of FIG. 1. FIGS. 5A to 5C and FIGS. 6A to 6C are views illustrating deformation of the chassis when an impact force is applied to the optical disc apparatus of FIG. 1.

In FIGS. 1 and 2, reference numeral 100 denotes an optical disc apparatus. Reference numeral 3 denotes a disc motor for rotating and driving an optical disc (not shown) as a recording medium. Reference numeral 4 denotes an optical pickup for irradiating a laser beam to the optical disc and receiving the reflected light. Reference numeral 10 denotes a lead screw member provided with a screw on a surface thereof to move the optical pickup 4 by rotation. Reference numeral 9 denotes a feed motor for rotating and driving the lead screw member 10. The lead screw member 10 and the feed motor 9 form a pickup moving mechanism for moving the optical pickup 4 in a substantially radial direction of the optical disc. Reference numeral 5 denotes a chassis on which the optical pickup, the pickup moving mechanism, and the disc motor 3 are mounted. Reference numeral 5a denotes an end portion (hereinafter referred to as a chassis end) in the X′ axis direction of the chassis 5. Reference numeral 7 denotes a motor fixed plate in which the disc motor 3 is fixed to the chassis 5. Reference numeral 8 denotes a flexible printed circuit (FPC) for electrically connecting the optical pickup 4 and a circuit board inside the apparatus. The chassis 5, disc motor 3, optical pickup 4, pickup moving mechanism, motor fixed plate 7, and flexible printed circuit 8 all form a mechanism portion of the optical disc apparatus 100. The chassis 5 forms the outer peripheral portion of the mechanism portion as a base of the mechanism portion, for example, by a steel plate with a thickness of 1.0×10⁻³ m.

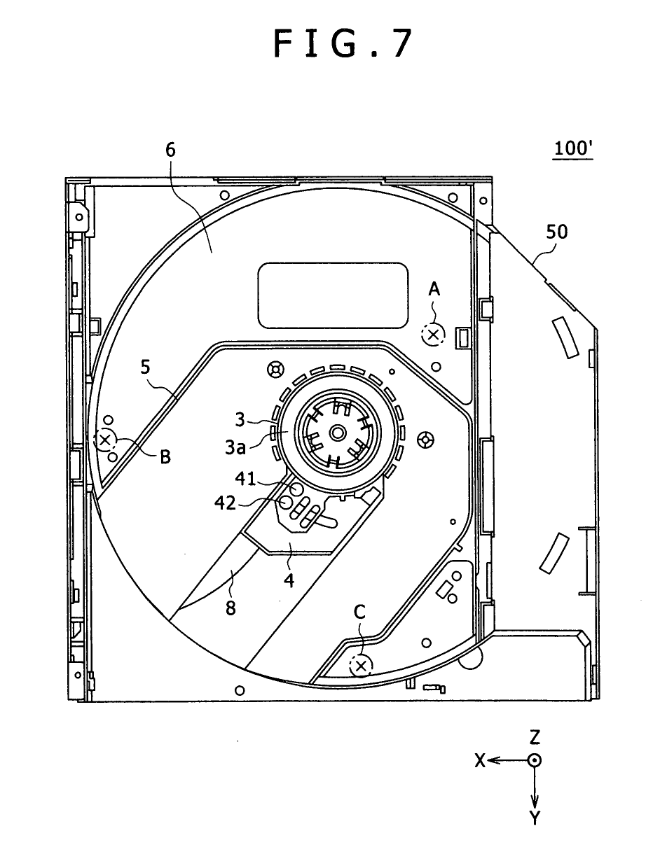

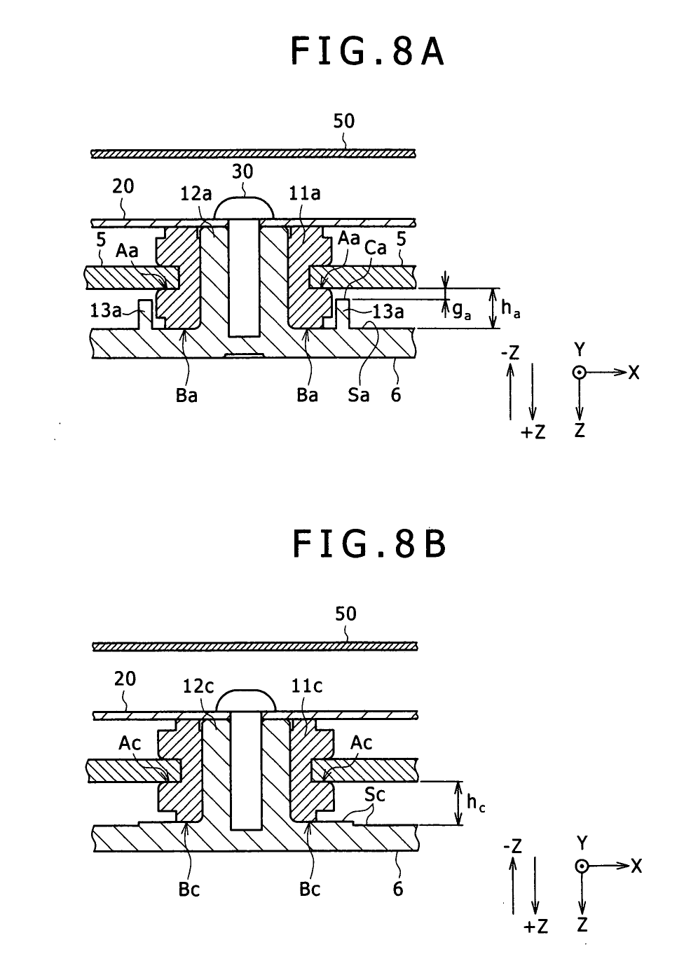

Further, reference numeral 6 denotes a tray for inserting or ejecting the optical disc into or from a body of the optical disc apparatus 100. Reference numeral 11a denotes a damper A as a vibration proof material for connecting the chassis 5 to the tray 6. Similarly, reference numeral 11b denotes a damper B, and 11c denotes a damper C. Reference numeral 12a denotes a damper engagement portion A in which the damper A 11a is engaged with the outer periphery thereof on the tray 6. Reference numeral 12c denotes a damper engagement portion C in which the damper C 11c is engaged with the outer periphery thereof on the tray 6. A damper engagement portion, with which the damper B 11b is engaged on the tray 6, has basically the same configuration as the damper engagement portion C. Hereinafter the damper engagement portion in which the damper B 11b is engaged with the outer periphery thereof on the tray 6 is referred to as a damper engagement portion B identified with reference numeral 12b. The tray 6 is molded by resin. The dampers A 11a, B 11b, C 11c are formed by a member having elasticity, such as rubber (including synthetic rubber) and synthetic resin. The damper engagement portions A 12a, B 12b, C 12c are projecting in a cylindrical manner from the plane of the tray 6 in the negative Z-axis direction, respectively. The dampers A 11a, B 11b, C 11c have a substantially cylindrical shape and are engaged in their hollow portions with the damper engagement portions A 12a, B 12b, and C 12c. The dampers A 11a, B 11b, C 11c are engaged with the chassis 5 in the middle portions of the respective dampers in the height direction of the outer peripheral surface (the negative Z-axis direction). In this way, the chassis 5 is supported by the engagement of the dampers. In other words, the chassis 5 is connected to the tray 6 through the dampers A 11a, B 11b, C 11c in the three positions of the damper engagement portions A 12a, B 12b, and C 12c. The connection structure of the chassis 5 to the tray 6 in the damper engagement portion A 12a, and the connection structure of the chassis 5 to the tray 6 in the damper engagement portion C 12c are the same as those shown in FIGS. 8A and 8B, respectively. The connection structure of the chassis 5 to the tray 6 in the damper engagement portion B 12b is the same as the connection structure in the damper engagement portion C 12c. Further, the configuration of the tray 6 in the peripheral portion of the connecting portion of the chassis 5 to the tray 6 through the damper A 11a is basically the same as the configuration shown in FIG. 8A. In addition, the positions of the damper engagement portions A 12a, B 12b, C 12c in FIGS. 1 and 2 are the same as those shown in FIG. 7, respectively. In other words, in the configuration in FIGS. 1 and 2, the damper engagement portion A 12a is located at a position corresponding to the position A in FIG. 7, the damper engagement portion B 12b is located at a position corresponding to the position B in FIG. 7, and the damper engagement portion C 12c is located at a position corresponding to the position C in FIG. 7. However, the configuration of the tray 6 in the peripheral portion of the connecting portion of the chassis 5 to the tray 6 through the damper B 11b as well as the configuration of the tray 6 in the peripheral portion of the connecting portion of the chassis 5 to the tray 6 through the damper C 11c, are different from that shown in FIG. 8B.

The bottom cover (not shown) for covering the back surface side of the tray 6 is provided above the end surfaces of the dampers A 11a, B 11b, C 11c in the negative Z-axis direction. The bottom cover is fixed by screws on the side of the damper engagement portions A 12a, B 12b, and C 12c. In the three positions, the dampers A 11a, B 11b, C 11c are supported in such a way that the end surfaces of the dampers on the side of the negative Z-axis direction come into contact with the plane of the bottom cover, respectively.

Further, reference numeral 13a denotes a rib A that is provided around the damper engagement portion A 12a and the damper A 11a in a substantially concentric manner, as a projecting portion projecting in the direction of the chassis (the negative Z-axis direction). Reference numeral 15 denotes a rib B as a projecting portion projecting in the chassis direction at a position facing the chassis 5 in the peripheral portion of the damper engagement portion B 12b and damper B 11b. Reference numeral 16 denotes a rib C as a projecting portion projecting in the chassis direction at a position facing the chassis 5 in the peripheral portion of the damper engagement portion C 12c and damper C 11c. The rib A 13a limits the amount of compressive displacement of the damper A 11a in the positive Z-axis direction, by coming into contact with the surface of the chassis 5 facing the rib A 13a (the chassis facing surface) when the chassis 5 moves in the positive Z-axis direction. Similarly, the rib B 15 limits the amount of compressive displacement of the damper B 11b in the positive Z-axis direction, by coming into contact with the surface of the chassis 5 facing the rib B 15 (the chassis facing surface) when the chassis 5 moves in the positive Z-axis direction. Also, the rib C 16 limits the amount of compressive displacement of the damper C 11c at the positions Z-axis direction, by coming into contact with the surface of the chassis 5 facing the rib C 16 (the chassis facing surface) when the chassis 5 moves in the positive Z-axis direction. The ribs B 15 and C 16 have a width of about 1.0×10⁻³ m and a length of about 2.0×10⁻³ m. The ribs B 15 and C 16 are molded by resin integrally with the tray 6 as part of the tray 6 in a similar manner to the rib A 13a. The tip end surface of the rib A 13a is formed, as shown in FIG. 8A, at a position that is higher than the height of the plane of the tray 6 with which the end surface in the positive Z-axis direction comes into contact, namely, higher than the height of the tray surface Sa in the peripheral portion of the damper engagement portion A 12a, and is lower than the height hₐ of the surface of the chassis 5 facing the tray 6. In FIG. 8A, the height hₐ is, for example, about 1.85×10⁻³ m. The distance gₐ from the tip end surface Ca of the rib A 13a to the surface of the chassis 5 facing the tray 6 is, for example, about 0.55×10⁻³ m. Further, the tip end surface of the rib B 15 is formed at a position that is higher than the height of the plane of the tray 6 with which the end surface of the damper B 11b in the positive Z-axis direction comes into contact, namely, higher than the height of the plane in the peripheral portion of the damper engagement portion B 12b, and is lower than the height of the surface of the chassis facing the tray 6. Similarly, the tip end surface of the rib C 16 is formed at a position that is higher than the height of the plane of the tray 6 with which the end surface of the damper C 11c in the positive Z-axis direction comes into contact, namely, higher than the height of the plane in the peripheral portion of the damper engagement portion C 12c, and is lower than the height of the surface of the chassis 5 facing the tray 6. The distanced from the tip end surface of the rib B 15 to the surface of the chassis facing the tray 6 is substantially equal to the distance from the tip end surface of the rib C 16 to the surface of the chassis 5 facing the tray 6.

Of the three connecting portions in which the chassis 5 is connected to the tray 6, the connecting portion through the damper A 11a is located more on the side of the tray insertion direction, namely, the negative X′-axis direction than the position in which the disc motor 3 is provided. The connecting portion through the damper B 11b and the connecting portion through the damper C 11c are located more on the side of the tray ejection direction, namely, the positive X′-axis direction than the position in which the disc motor 3 is provided. Further, of the projecting portions of the tray 6, the rib A 13a is located more on the side of the tray insertion direction (the negative Y-axis direction) than the position of the disc motor 3. The ribs B 15 and C 16 are located more on the side of the tray ejection direction (the positive Y-axis direction) than the position of the disc motor 3. In addition, the rib B 15 is located on the outer peripheral side of the disc, as well as more on the side of the tray ejection direction (the positive Y-axis direction) than the connecting portion through the damper B 11b. The rib C 16 is located on the outer peripheral side of the disc, as well as more on the side of the tray ejection direction (the positive Y-axis direction) than the connecting portion through the damper C 11c. Further, the rib B 15 is located at a position closer to the side of the optical pickup 4 and its movement area (the space in which the optical pickup 4 moves) than the connecting portion through the damper B 11b. The rib C 16 is located at a position closer to the side of the optical pickup 4 and its movement area (the space in which the optical pickup 4 moves) than the connecting portion through the damper C 11c. Still further, the ribs B 15 and C 16 are designed so that the distance from the disc motor 3 is longer than the case of the rib A 13a. The rib C 16 close to the feed mechanism is located farther from the disc motor 3 than the rib B 15 far from the feed mechanism. In order to reduce the amount of deformation of the chassis 5 and to downsize the apparatus, the ribs A 13a, B 15, C 16 are provided in positions within at least 30×10⁻³ m from the vibration proof materials that are located closest to the respective ribs. For example, the rib A 13a is provided at a position away from the damper A 11a by about 2×10⁻³ to 10×10⁻³ m, the rib B 15 is provided at a position away from the damper B 11b by about 20×10⁻³ to 25×10⁻³ m, and the rib C 16 is provided at a position away from the damper C 11 by about 15×10⁻³ to 20×10⁻³ m.

Hereinafter, the same reference numerals shown in FIGS. 1, 2 and FIGS. 8A, 8B will be employed as those for denoting the same components shown in FIGS. 1, 2 and FIGS. 8A, 8B.

FIG. 3 is a cross-sectional view showing the connection structure of the chassis 5 to the tray 6 as well as the configuration of the tray 6 in the peripheral portion thereof in the optical disc apparatus 100 of FIG. 1. The connection structure shows the structure for connecting the chassis 5 to the tray 6 through the damper C 11c in the damper engagement portion C 12c.

In FIG. 3, reference numeral 11c₁ denotes a first portion of the damper C 11c on the side of the negative Z-axis direction than the chassis 5. Reference numeral 11c₂ denotes a second portion of the damper C 11c on the side of the positive Z-axis direction than the chassis 5. Reference symbol Ac denotes a surface in the negative Z-axis direction of the second portion coming into contact with the chassis 5. Reference symbol Bc denotes an end surface (hereinafter referred to as a lower end surface) in the positive Z-axis direction of the damper C 11c coming into contact with the tray surface Sc. Reference symbol h_{c} denotes a height of the chassis 5 from the tray surface Sc. Reference symbol g_{c} denotes a distance (gap) between a tip end surface Cc of the rib C 16 and a surface of the chassis 5 facing the rib. Reference numeral 50 denotes a bottom case for covering the back surface side (the negative Z-axis direction) of the apparatus. Reference numeral 20 denotes a bottom cover provided inside the bottom case 50 to cover the back surface side of the tray including the mechanism portion. Reference numeral 30 denotes a screw for fixing the bottom cover 20 to the damper engagement portion C 12c of the tray 6. Here the height h_{c} is, for example, about 0.95×10⁻³ mm, and the distance g_{c} is, for example, about 0.25×10⁻³ mm.

For example, when an impact force is applied to the optical disc apparatus 100 in the positive Z-axis direction, the chassis 5 pushes the surface Ac of the damper C 11c in the positive Z-axis direction. As a result, a compressive force is applied to the damper C 11c between the surface Ac and the end surface Bc to compress and displace the second portion 11c₂. Due to the compressive displacement, the chassis 5 also moves in the positive Z-axis direction. When the chassis 5 moves by the distance g_{c}, the surface of the chassis 5 facing the rib C 16 comes into contact with the tip end surface Cc of the rib C 16. Due to the contact, the movement of the chassis 5 is stopped, and the compressive displacement in the second portion 11c₂ of the damper C 11c is also stopped. In other words, the rib C 16 limits the amount of movement of the chassis 5 in the positive Z-axis direction due to the impact force as well as the amount of compressive displacement of the damper C 11c in the positive Z-axis direction, to an amount substantially equal to the distance g_{c}. When an impact force is applied to the optical disc apparatus 100 in the negative Z-axis direction, the damper A 11a is largely compressed and displaced in the negative Z-axis direction. With this influence, the chassis 5 is largely inclined to compress and displace the first portion 11c₁ of the damper C 11c. Due to the compressive deformation, the chassis 5 also moves in the negative Z-axis direction. When the chassis 5 moves by the distance g_{c}, the surface of the chassis 5 facing the rib C 16 comes into contact with the tip end surface Cc of the rib C 16. Due to the contact, the movement of the chassis 5 is stopped, and the compressive displacement in the second portion 11c₂ of the damper C 11c is also stopped. In other words, also in this case, the rib C 16 limits the amount of movement of the chassis 5 in the negative Z-axis direction due to the impact force as well as the amount of compressive displacement of the damper C 11c in the negative Z-axis direction, to an amount substantially equal to the distance g_{c}. In the connection structure of the chassis 5 to the tray 6 through the damper B 11b, similarly to the case of the rib C 16, the amount of movement of the chassis 5 in the positive or negative Z-axis direction due to the impact force as well as the amount of compressive displacement of the damper B 11b in the positive or negative Z-axis direction, are limited to a small amount by the rib B 15.

Hereinafter, the same reference numerals shown in FIG. 3 will be employed as those for denoting the same components shown in FIG. 3.

FIG. 4 is an enlarged plan view of the peripheral portions of the connecting portions of the chassis in the optical disc apparatus 100 of FIG. 1.

In FIG. 4, the chassis 5 is shown by the two dotted lines. On the tray 6, the rib B 15 is integrally formed on the outer peripheral side of the disc, as well as more on the side of the tray ejection direction (the positive X′ axis direction) than the connecting portion through the damper B 11b. The rib C 16 is integrally formed on the outer peripheral side of the disc, as well as more on the side of the tray ejection direction (the positive X′ direction) than the connecting portion of the chassis 5 to the tray 6 through the damper C 11c. The ribs B 15, C 16 are located in positions in which the width of the chassis 5 facing the ribs is made as large as possible. The width w₁ of the portion of the chassis 5 facing the rib B 15 is, for example, about 2.5×10⁻³ m. The width w₂ of the portion of the chassis 5 facing the rib C 16 is, for example, about 5.0×10⁻³ m.

FIGS. 5A to 5C and 6A to 6C are views illustrating deformation of the chassis when an impact force is applied to the optical disc apparatus 100 of FIG. 1. FIGS. 5A to 5C show a case in which an impact force is applied to the optical disc apparatus 100 in the negative Z-axis direction. FIGS. 6A to 6C show a case in which an impact force is applied in the positive Z-axis direction.

FIG. 5A shows the state of the chassis 5, damper A 11a, damper B 11b, and damper C 11c before the impact force is applied. FIG. 5B shows the state of these components when the impact force is applied to the optical disc apparatus 100 in the negative Z-axis direction. FIG. 5C shows the state after the impact force is removed.

In the state before the impact force is applied to the optical disc apparatus 100 (FIG. 5A), the whole or some of the weight of the mechanism portion including the chassis 5 is loaded on the dampers A 11a, B11b, and C11c through the chassis 5. For example, the whole weight of the mechanism portion is loaded when the optical disc apparatus 100 is in a state in which the negative or positive Z-axis direction extends vertically upward, and otherwise some of the weight of the mechanism portion is loaded. The dampers A 11a, B 11b, C 11c share and support the load by the respective elastic restoring forces. At this time, in the connecting portion of the chassis 5 to the tray 6 through the damper A 11a, the distance gₐ (FIG. 8A) from the tip end surface Ca (FIG. 8A) of the rib A 13a to the surface of the chassis 5 facing the tray 6 is, for example, about 0.55×10⁻³ m. In the connecting portion of the chassis 5 to the tray 6 through the damper B 11b, the distance from the tip end surface of the rib B 15 to the surface of the chassis 5 facing the tray 6 is, for example, about 0.25×10⁻³ m. Similarly, in the connecting portion of the chassis 5 to the tray 6 through the damper C 11c, the distance from the tip end surface Cc (FIG. 3) of the rib C 16 to the surface of the chassis 5 facing the tray 6 is, for example, about 0.25×10⁻³ m. Thus no deformation occurs in the chassis end 5a.

In the state in which the impact force is applied to the optical disc apparatus 100 in the negative Z-axis direction (FIG. 5B), the damper A 11a is pushed and compressed in the negative Z-axis direction by the chassis 5 due to the impact force. In this case, there is no component that limits the movement of the chassis 5 between the inner surface of the bottom cover 20 and the chassis 5, so that the damper A 11a is largely compressed in response to the magnitude of the impact force. As a result, the side of the portion of the chassis 5 engaged with the damper A 11a, namely, the side of the connecting portion of the chassis 5 to the tray 6 through the damper A 11a largely moves in the negative Z-axis direction along with the compression of the damper A 11a. The chassis 5 is largely inclined to the side of the connecting portion to the tray 6 through the damper B 11b and of the connecting portion to the tray 6 through the damper C 11c. Due to the inclination, the chassis 5 moves in the positive Z-axis direction on the side of the connecting portion to the tray 6 through the damper B 11b and of the connecting portion to the tray 6 through the damper C 11c. When the chassis 5 moves in the positive Z-axis direction by the distance g_{c} (FIG. 3), the surface of the chassis 5 facing the tip end surface Cc (FIG. 3) of the rib C 16 comes into contact with the tip end surface Cc (FIG. 3) of the rib C 16, and then is displaced. Similarly, when the chassis 5 moves by the distance of the gap between the tip end surface of the rib B 15 and the surface of the chassis 5 facing the rib, the chassis facing surface comes into contact with the tip end surface of the rib B 15, and then is displaced.

In the state in which the impact force is removed (FIG. 5C), the chassis 5 is returned to substantially the original position in the negative Z-axis direction by the restoring forces of the dampers A 11a, B 11b, C 11c, in the connecting portions of the chassis 5 to the tray 6 through the dampers A 11a, B 11b, C 11c, respectively. However, as described above, the chassis 5 comes into contact with the tip end surface of the rib B 15 and with the tip end surface Cc of the rib C 16 due to the impact force in the negative Z-axis direction, so that a slight plastic deformation remains in the chassis end 5a, namely, the state of the chassis end 5a changes from 5a₁ to 5a₂. However, the amount of plastic deformation is maintained at a level in which the normal operation of the optical disc apparatus 100 is not prevented.

Further, FIG. 6A shows the state of the chassis 5, damper A 11a, damper B 11b, and damper C 11c before the impact force is applied. FIG. 6B shows the state of displacement and deformation of these components when the impact force is applied to the optical disc apparatus 100 in the positive Z-axis direction. FIG. 6C shows the state after the impact force is removed.

In the state before the impact force is applied to the optical disc apparatus 100 (FIG. 6A), the chassis 5, damper A 11a, damper B 11b, and damper C 11c are in the same state as in the case of FIG. 5A. In other words, the whole or some of the weight of the mechanism portion including the chassis 5 is loaded through the chassis 5. For example, the whole weight of the mechanism portion is loaded when the optical disc apparatus 100 is in a state in which the positive or negative Z-axis direction extends vertically upward, and otherwise some of the weight is loaded. The dampers A 11a, B 11b, C 11c share and support the load by the respective elastic restoring forces. At this time, in the connecting portion of the chassis 5 to the tray 6 through the damper A 11a, the distance gₐ from the tip end surface Ca (FIG. 8A) of the rib A 13a to the surface of the chassis 5 facing the tray 6 is, for example, about 0.55×10⁻³ m. In the connecting portion of the chassis 5 to the tray 6 through the damper B 11b, the distance from the tip end surface of the rib B 15 to the surface of the chassis 5 facing the tray 6 is, for example, about 0.25×10⁻³ m. Similarly, in the connecting portion of the chassis 5 to the tray 6 through the damper C 11c, the distance from the tip end surface of the rib C 16 to the surface of the chassis 5 facing the tray 6 is, for example, about 0.25×10⁻³ m. Thus no deformation occurs in the chassis end 5a.

In the state in which the impact force is applied to the optical disc apparatus 100 in the positive Z-axis direction (FIG. 6B), the chassis 5 pushes a surface Aa (FIG. 8A) of the damper A 11a in the positive Z-axis direction in the connecting portion of the chassis 5 to the tray 6 through the damper A 11a. As a result, a compressive force is applied to the damper A 11a between the surface Aa and an end surface Ba (FIG. 8A) to compress and displace a portion between the surface Aa and the end surface Ba. Due to the compressive displacement, the chassis 5 also moves in the positive Z-axis direction. When the chassis 5 moves by the distance gₐ (FIG. 8A), the facing surface of the chassis 5 comes into contact with the tip end surface Ca (FIG. 8A) of the rib A 13a. Due to the contact, the movement of the chassis 5 is stopped, and the compressive displacement between the surface Aa and end surface Ba of the damper A 11a is also stopped. Further, in the connecting portion of the chassis 5 to the tray 6 through the damper C 11c, the chassis 5 pushes the surface Ac (FIG. 3) of the damper C 11c in the positive Z-axis direction. As a result, a compressive force is applied to the damper C 11c between the surface Ac and the end surface Bc (FIG. 3) to compress and displace the second portion 11c₂ (FIG. 3). Due to the compressive displacement, the chassis 5 also moves in the positive Z-axis direction. When the chassis 5 moves by the distance g_{c} (FIG. 3), the facing surface of the chassis 5 comes into contact with the tip end surface Cc (FIG. 3) of the rib C 16. Due to the contact, the movement of the chassis 5 is stopped, and the compressive displacement of the second portion 11c₂ of the damper C 11c is also stopped. Further, in the connecting portion of the chassis 5 to the tray 6 through the damper B 11b, the chassis 5 pushes the damper B 11b in the positive Z-axis direction in a similar manner to the connecting portion of the chassis 5 to the tray 6 through the damper B 11b. As a result, a compressive force is applied to the damper B 11b between the chassis 5 and the tray 6 to compress and displace the portion therebetween. Due to the compressive displacement, the chassis 5 also moves in the positive Z-axis direction. When the chassis moves by the distance of the gap between the tip end surface of the rib B 15 and the surface of the chassis 5 facing the rib, the chassis facing surface comes into contact with the tip end surface of the rib B 15. Due to the contact, the movement of the chassis 5 is stopped, and the compressive displacement of the relevant portion of the damper B 11b is also stopped.

In the state in which the impact force in the positive Z-axis direction is removed (FIG. 6C), the chassis 5 is returned to substantially the original position by the restoring forces of the dampers A 11a, B 11b, C 11c, in the connecting portions of the chassis 5 to the tray 6 through the dampers A 11a, B 11b, C 11c, respectively. However, as described above, the chassis 5 comes into contact with the tip end surface of the rib B 15 and with the tip end surface Cc (FIG. 3) of the rib C 16 due to the impact force in the positive Z-axis direction, so that a slight plastic deformation remains in the chassis end 5a, namely, the state of the chassis end 5a changes from 5a₁ to 5a₃. However, the amount of plastic deformation is maintained at a level in which the normal operation of the optical disc apparatus 100 is not prevented.

As described above, the optical disc apparatus 100 according to the present invention can prevent deformation of the chassis 5 due to the impact force, and improve the reliability of the apparatus.

Incidentally, in the above embodiment, the distance between the rib A 13a and the surface of the chassis 5 facing the rib is different from the distance between the rib B 15 and the surface of the chassis 5 facing the rib, and different from the distance between the rib C 16 and the surface of the chassis 5 facing the rib. However, the present invention is not limited thereto, and may have the same value for the distances. Further, the distance between the rib B 15 and the surface of the chassis 5 facing the rib, and the distance between the rib C 16 and the surface of the chassis 5 facing the rib may be different from each other.

As described above, according to the present invention, the optical disc apparatus can prevent deformation of the chassis of the mechanism portion due to the impact force, and improve the reliability of the apparatus.

The present invention can be carried out also in other modes than the above embodiment without departing from the spirit or principal features of the present invention. Therefore, the above described embodiment is merely an example of the present invention throughout the description and should not be limitedly understood. The scope of the present invention is indicated by the following claims. Further, modifications and changes belonging to the equivalent scope of the claims are all within the scope of the present invention.

What is claimed is:

1. An optical disc apparatus for recording or reproducing information on an optical disc, comprising:
an optical pickup for irradiating a laser beam onto the optical disc and receiving reflected light;
a pickup moving mechanism for moving the optical pickup in a substantially radial direction of the optical disc;
a disc motor for rotating and driving the optical disc;
a chassis on which the optical pickup, the pickup moving mechanism, and the disc motor are mounted; and
a tray for inserting or ejecting the optical disc into or from an apparatus body, with the chassis connected thereto through vibration proof materials in a plurality of portions in a surface opposite a surface on which the disc is placed,
wherein the tray has projecting portions projecting in the chassis direction, in positions facing the chassis in peripheral portions of each of the plurality of connecting portions in which the chassis is connected, and
the projecting portion has a tip end surface formed at a position that is higher than the height of a tray plane with which the vibration proof material comes into contact, and is lower than the height of a surface of the chassis facing the tray.

2. The optical disc apparatus according to claim 1,
wherein the chassis is connected to the tray in three portions, one of the portions being located more on the side of a tray insertion direction than the position of the disc motor, and the other two portions being located more on the side of a tray ejection direction than the position of the disc motor.

3. The optical disc apparatus according to claim 1,
wherein the tray has the two projecting portions located more on the side of a tray ejection direction than the position of the disc motor.

4. The optical disc apparatus according to claim 1,
wherein the tray has the three projecting portions, one of the projecting portions being located more on the side of a tray insertion direction than the position of the disc motor, and the other two projecting portions being located more on the side of a tray ejection direction than the position of the disc motor.

5. The optical disc apparatus according to claim 1,
wherein the tray has the two projecting portions on the side of a tray ejection direction than the position of the disc motor, each of the projecting portions being located more on the side of the tray ejection direction than each of the corresponding connecting portions of the chassis.

6. The optical disc apparatus according to claim 1,
wherein the tray has the two projecting portions on the side of a tray ejection direction than the position of the disc motor, each of the projecting portions being located on an outer peripheral side of the disc than each of the corresponding connecting portions of the chassis.

7. The optical disc apparatus according to claim 1,
wherein the tray has the three projecting portions, one of the projecting portions being located more on the side of a tray insertion direction than the position of the disc motor, and the other two projecting portions being located more on the side of a tray ejection direction than the position of the disc motor, as well as on the side of the tray ejection direction than each of the corresponding connecting portions of the chassis.

8. The optical disc apparatus according to claim 1,
wherein the tray has the three projecting portions, one of the projecting portions being located more on the side of a tray insertion direction than the position of the disc motor, and the other two projecting portions being located more on the side of a tray ejection direction than the position of the disc motor, each having a distance from the disc motor longer than that of the former one.

9. The optical disc apparatus according to claim 1,
wherein the tray has the two projecting portions located more on the side of a tray ejection direction than the position of the disc motor, and of the two projecting portions, the one close to the feed mechanism being located further from the position of the disc motor than the other one far from the feed mechanism.

10. The optical disc apparatus according to claim 1,
wherein the tray has the projecting portions each formed at a position within 30×10⁻³ m from each of the vibration proof materials closest to the projecting portions.

11. The optical disc apparatus according to claim 2,
wherein the tray has the projecting portions each formed at a position within 30×10⁻³ m from each of the vibration proof materials closest to the projecting portions.

12. The optical disc apparatus according to claim 3,
wherein the tray has the projecting portions each formed at a position within 30×10⁻³ m from each of the vibration proof materials closest to the projecting portions.

13. The optical disc apparatus according to claim 4,
wherein the tray has the projecting portions each formed at a position within 30×10⁻³ m from each of the vibration proof materials closest to the projecting portions.

14. The optical disc apparatus according to claim 5,
wherein the tray has the projecting portions each formed at a position within 30×10³ m from each of the vibration proof materials closest to the projecting portions.

15. The optical disc apparatus according to claim 6,
wherein the tray has the projecting portions each formed at a position within 30×10⁻³ m from each of the vibration proof materials closest to the projecting portions.

16. The optical disc apparatus according to claim 7,
wherein the tray has the projecting portions each formed at a position within 30×10⁻³ m from each of the vibration proof materials closest to the projecting portions.

17. The optical disc apparatus according to claim 8,
wherein the tray has the projecting portions each formed at a position within 30×10⁻³ m from each of the vibration proof materials closest to the projecting portions.

18. The optical disc apparatus according to claim 9,
wherein the tray has the projecting portions each formed at a position within 30×10⁻³ m from each of the vibration proof materials closest to the projecting portions.
